(19) United States
(12) Patent Application Publication
(10) Pub. No.: US 2013/0290896 A1
(43) Pub. Date: Oct. 31, 2013

(54) Symbol Disambiguation

(71) Applicant: Ching-Lan Huang, Santa Clara, CA (US)

(72) Inventor: Ching-Lan Huang, Santa Clara, CA (US)

(73) Assignee: APPLE INC., Cupertino, CA (US)

(21) Appl. No.: 13/460,714

(22) Filed: Apr. 30, 2012

(51) Int. Cl. G06F 3/048

(52) U.S. Cl. 715/780

(57) ABSTRACT

In some implementations, when a user is providing input to a text input interface, a user can be presented with a list of symbols related to a current symbol input. The list of related symbols can include the related symbols and a description of each symbol. The related symbols can be a predefined list of symbols that are related to the current symbol input by similar appearance, similar sound, commonly observed error and/or shared keyboard key. The related symbols can include user-defined symbols.

### TECHNICAL FIELD

The disclosure generally relates to text input techniques.

### BACKGROUND

Modern text input interfaces often provide assistance to the user. For example, text input interfaces often provide word completion features that attempt to anticipate the word that the user is currently typing.

### SUMMARY

In some implementations, when a user is providing input to a text input interface, a user can be presented with a list of symbols related to a current symbol input. The list of related symbols can include the related symbols and a description of each symbol. The related symbols can be a predefined list of symbols that are related to the current symbol input by similar appearance, similar sound, commonly observed error and/or shared keyboard key. The related symbols can include user-defined symbols.

Particular implementations provide at least the following advantages: Providing descriptions of the symbols in the related symbol list avoids user confusion about what each symbol is. Users can quickly identify and correct errors in symbol input.

Details of one or more implementations are set forth in the accompanying drawings and the description below. Other features, aspects, and potential advantages will be apparent from the description and drawings, and from the claims.

### DESCRIPTION OF DRAWINGS

FIG. 1 illustrates an example graphical interface for symbol disambiguation.

FIG. 2 illustrates an example graphical interface for user-defined symbol generation.

FIG. 3 illustrates an example graphical interface for removing symbols from the related symbols list.

FIG. 4 is flow diagram of an example symbol disambiguation process.

FIG. 5 is flow diagram of an example user-defined symbol generation process.

FIG. 6 is flow diagram of an example symbol deletion process.

FIG. 7 is a block diagram of an exemplary system architecture implementing the features and processes of FIGS. 1-6.

Like reference symbols in the various drawings indicate like elements.

### DETAILED DESCRIPTION

This disclosure describes various Graphical User Interfaces (UIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” user interface elements in a GUI, these terms are understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radial buttons, checkboxes and any other mechanism for receiving input from, or providing feedback to a user.

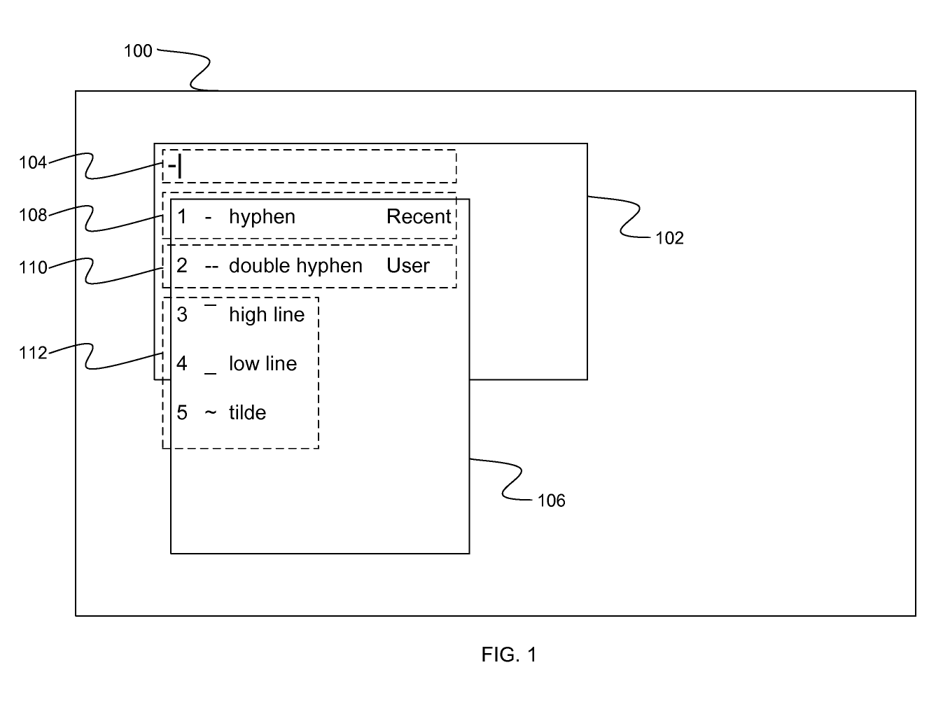

FIG. 1 illustrates an example graphical interface 106 for symbol disambiguation. For example, graphical interface 100 can be a desktop or workspace interface for a computing device (e.g., laptop computer, tablet computer, desktop computer, smartphone, etc.). Graphical interface 100 can include text input interface 102. For example, text input interface 102 can be an interface of an application (e.g., word processor, text messaging application, browser, etc.) capable of receiving text input. Text input interface 102 can include a text input area 104. For example, as a user provides text input (e.g., types input on a physical or virtual keyboard), the text can appear in text input area 104.

In some implementations, when a user provides symbol input (the current symbol input) in text input interface 102, symbol disambiguation interface 106 can be displayed. For example, if the user provides text input corresponding to a symbol (e.g., punctuation), symbol disambiguation interface 106 can be displayed. As illustrated by FIG. 1, a user can input a hyphen (“−”) followed by another input key (e.g., space bar, control key, alt key, up arrow, down arrow, etc.) indicating the end of symbol input to cause symbol disambiguation interface 106 to be displayed near input area 104. In some implementations, symbol disambiguation interface 106 can be automatically displayed in response to received symbol input.

In some implementations, symbol disambiguation interface 106 can include a list of symbols related to the current symbol input by the user in text input area 104. Each of the related symbol entries in the list can include a related symbol and a description of the symbol. For example, the description of the related symbol can provide the user with information that the user can use to distinguish between two or more symbols that have similar appearances. The symbol description for each related symbol can be presented inline (e.g., proximate to and on the same line) with the corresponding related symbol in the related symbols list.

In some implementations, the related symbols can be predefined. For example, a predefined mapping of symbols can be stored on the computing device. Symbols related to the current symbol input can be found by indexing the symbol map using the current symbol input. The related symbols displayed in interface 106 can include the current symbol input.

In some implementations, the symbols can be related based on similar appearance, similar sound, common input mistakes and/or shared keyboard key. For example, the hyphen “−” has a visual appearance similar to many other types of symbols and/or punctuation. The hyphen is similar to an underline, macron and a tilde, for example. Some symbols can be associated with common input mistakes. For example, a user may intend to enter a plus (+) symbol, but mistakenly enter the equal (=) sign because the plus and equal symbols share the same keyboard key. Symbol disambiguation interface 106 can be presented to assist the user in correcting these input mistakes.

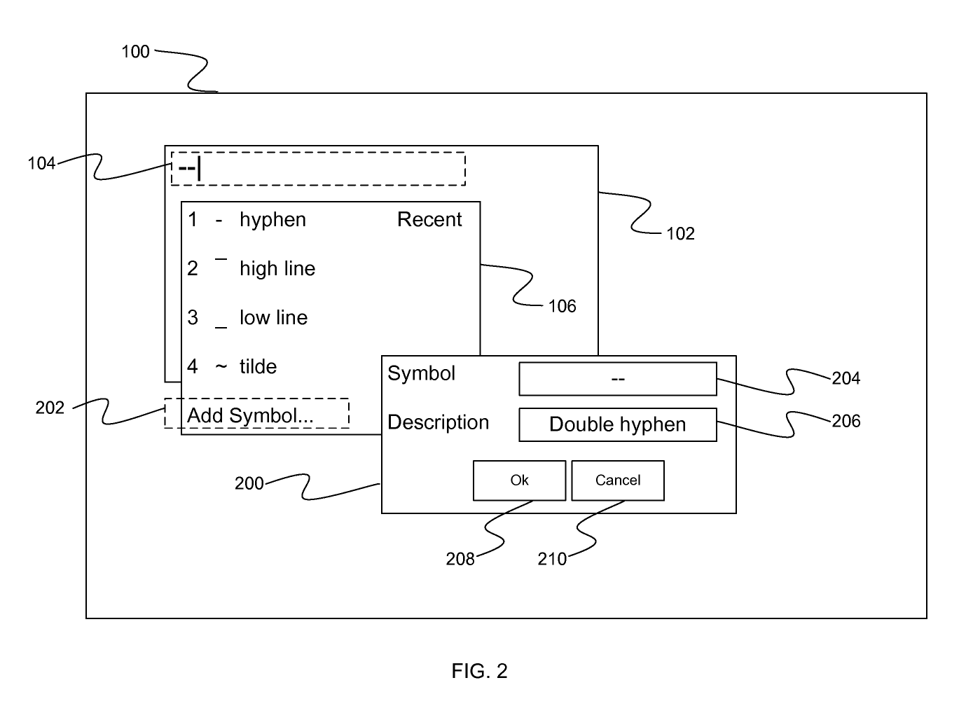

In some implementations, the related symbols listed in disambiguation interface 106 can be sorted based on frequency of use, classifications associated with each symbol, alphabetically, and visual and/or audible similarity to the current symbol input. For example, symbol entries in symbol disambiguation interface 106 can be classified as recently selected (“Recent”) or user-defined (“User) entries. Recently selected symbols 108 can be placed at the top of the related symbols list in symbol disambiguation interface 106. User-defined symbols 110 can correspond to symbols that a user has generated or created and that relate to the current symbol input, as described with reference to FIG. 2 below. The remaining predefined symbols 112 can be listed beneath the recent and user-defined symbols. The related symbols can be sorted based on frequency of use or how similar each symbol is to the current symbol input. For example, the symbol mapping described above can include a ranking for each related symbol that indicates how similar a related symbol is to the current symbol input.

FIG. 2 illustrates an example graphical interface 200 for user-defined symbol generation. In some implementations, a user can define a symbol and the user-defined symbol can be stored and presented upon subsequent invocation of symbol disambiguation interface 106. In some implementations, symbol disambiguation interface 106 can present a selectable graphical element 202 for invoking interface 200. For example, if the current symbol input does not match any symbols stored on the computing device, an “add symbol” option (graphical element 202) can be presented on symbol disambiguation interface 106.

In some implementations, when the user selects graphical element 202, graphical interface 200 can be presented to allow the user to generate a user-defined symbol. For example, the current symbol input can be presented in symbol input area 204 as the user-defined symbol. The user can adjust or modify the current symbol input in symbol input area 204 to add or remove elements to the user-defined symbol. For example, the user-defined symbol can be a combination of one or more characters or symbols. The user can provide a description of the user-defined symbol in description input area 206. If the user wishes to store the user-defined symbol for future use, the user can select graphical element 208 (e.g., “Ok” button). If the user wishes to discard the user-defined symbol, the user can select graphical element 201 (e.g., “Cancel” button).

In some implementations, the user-defined symbol can be automatically related to one or more other symbols. For example, once the user-defined symbol is stored, it can be related to other symbols based on the relationships already created for the predefined symbols. For example, if the user-defined symbol is a double hyphen, the double hyphen symbol can be automatically related to other hyphen-related symbols. If the user-defined symbol is a combination of symbols (e.g., “?!”), the user-defined symbol can be related to each of the individual symbols that make up the combination. For example, the user-defined ‘?!’ symbol can be related to the question mark (“?”) and exclamation mark (“!”) symbols and their related symbols.

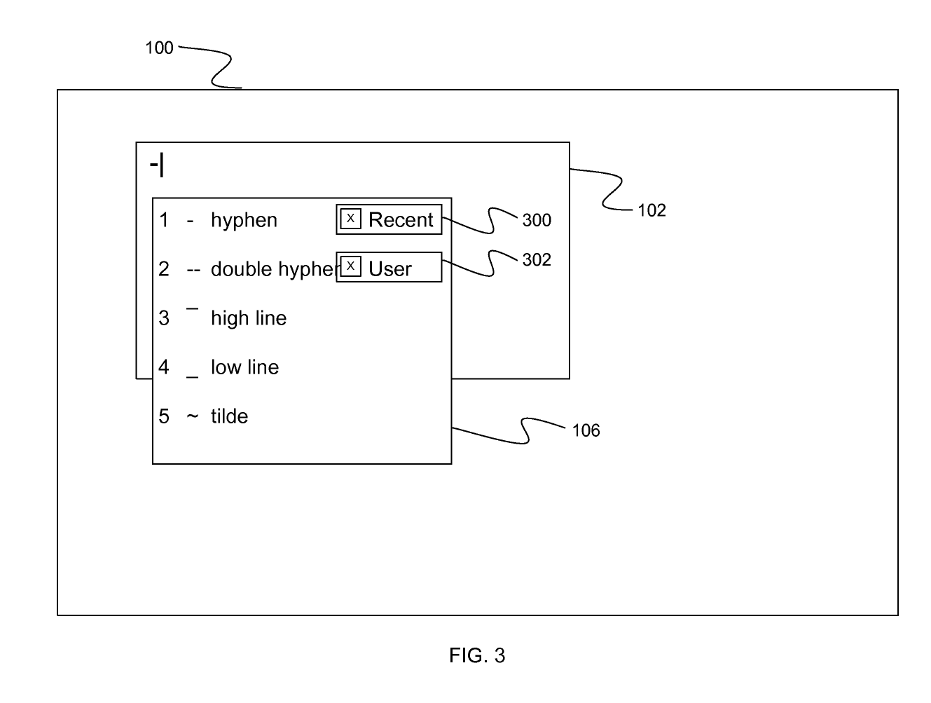

FIG. 3 illustrates example graphical interface elements 300 and 302 for removing symbols from the related symbols list of disambiguation interface 106. In some implementations, a user can remove a symbol from the list of recently selected symbols. In some implementations, the symbols that the user has recently selected can be displayed at the top of the related symbols list displayed in disambiguation interface 106. For example, the computing device can track the last ten (or five, or three, etc.) symbols that the user has previously selected and that are related to the current symbol input. The previously selected symbols can be presented at the top of the related symbols list so that the user can quickly select these symbols.

In some implementations, if a user wishes to remove one or more of the symbols from the recent symbols list, the user can select the symbol to remove and delete the symbol. In some implementations, selecting the symbol can be performed by hovering the cursor over the “Recent” label associated with the symbol to cause selectable graphical element 300 to appear. For example, hovering can cause the “Recent” label to become selectable to delete the associated symbol. The user can then select graphical element 300 to delete the symbol from the list of recently selected symbols. Graphical element 300 can also be invoked by performing a touch gesture with respect to the symbol to delete. For example, a user can provide input in the form of a swipe gesture over a symbol in the recent symbol list to cause graphical element 300 to be displayed. The user can then provide touch input (e.g., a tap) to graphical element 300 to delete the symbol from the recent symbols list. Keyboard input (e.g., depressing the shift key) can cause graphical element 300 do be displayed and a subsequent selection of graphical element 300 can delete the associated symbol from the list of recently selected symbols.

In some implementations, a symbol that is deleted from the recent symbols list can still be selected from the predefined symbols list displayed on disambiguation interface 106. For example, deleting a symbol from the recent symbols list merely removes the symbol from the list of recently selected symbols at the top of the symbols list. Deleting a symbol from the recent symbols list does not delete the symbol from the related symbol mappings and does not delete the symbol from storage on the computing device.

In some implementations, a user can delete a user-defined symbol. For example, user-defined symbols can be displayed on symbol disambiguation interface 106. If a user wishes to remove a user-defined symbol, the user can invoke delete graphical element 302 by hovering a cursor over the “User” label or by performing a touch gesture (e.g., a swipe gesture) associated with the symbol to be deleted and/or providing keyboard input, as described above. Once graphical element 302 is invoked, the user can select graphical element 302 to delete the user-defined symbol from disambiguation interface 106. In some implementations, selecting graphical element 302 can permanently delete the user-defined symbol from the computing device and future invocations of disambiguation interface 106 will not display the deleted user-defined symbol.

### Example Processes

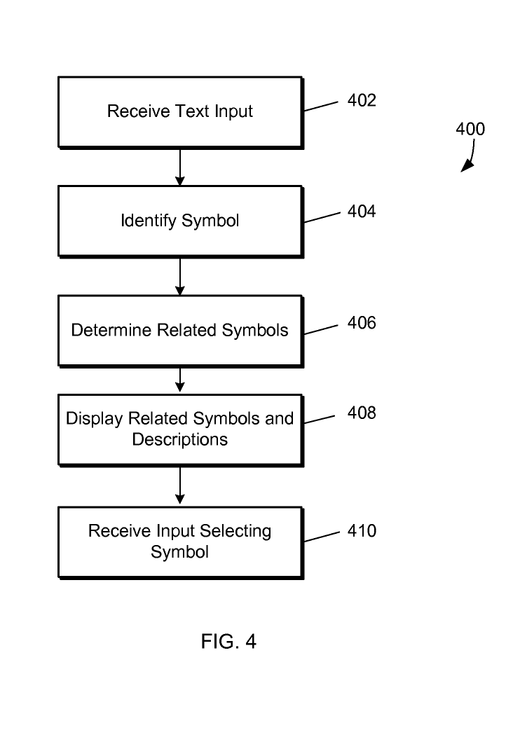

FIG. 4 is flow diagram 400 of an example symbol disambiguation process. At step 402, text input can be received. For example, text input can be received at an application running on a computing device. The application can be any program or function configured to receive text input. For example, the application can be a word processing application. The text input can be provided by any input device capable of providing text input. For example, the text input can be provided by a keyboard. In some implementations, the text input can include a symbol (e.g., a punctuation mark).

At step 404, the symbol in the text input can be identified. For example, the symbol can be identified as a question mark, a period or a hyphen, among other symbols. In some implementations, the symbol can be identified upon receiving input indicating that the user is done inputting the symbol. For example, if the user inputs one or more symbols followed by a space, the computing device can interpret the space as indicating that the user is done inputting the symbol and then the symbol can be identified. The end of the symbol input can be indicated by providing other input as well, such as tab key input, control key input, a touch gesture (e.g., a swipe) or other input. For example, any input that does not produce a visible character or symbol can be used to indicate the end of current symbol input. In some implementations, multiple symbols can be identified. For example, if a symbol includes a combination of symbols, then each symbol that makes up the combination can be identified and used to identify related symbols.

At step 406, symbols related to the current symbol input can be determined. For example, the current symbol input can be used to index into a look up table or mapping that associates the current symbol input to related symbols. The related symbols can include predefined symbols and/or user-defined symbols. The mapping can include metadata for each symbol that includes a description of each symbol. The metadata can also include tags that identify recently selected symbols and user-defined symbols.

At step 408, the related symbols and the symbol descriptions can be displayed. For example, the related symbols and the metadata from the symbol mapping or lookup table can be displayed in response to the user entering the current symbol input.

At step 410, input selecting a related symbol can be received. For example, if the user wishes to change the current symbol input, the user can select one of the related symbols that are displayed in the related symbols list. The selected symbol will then replace the current symbol input as the input to the application.

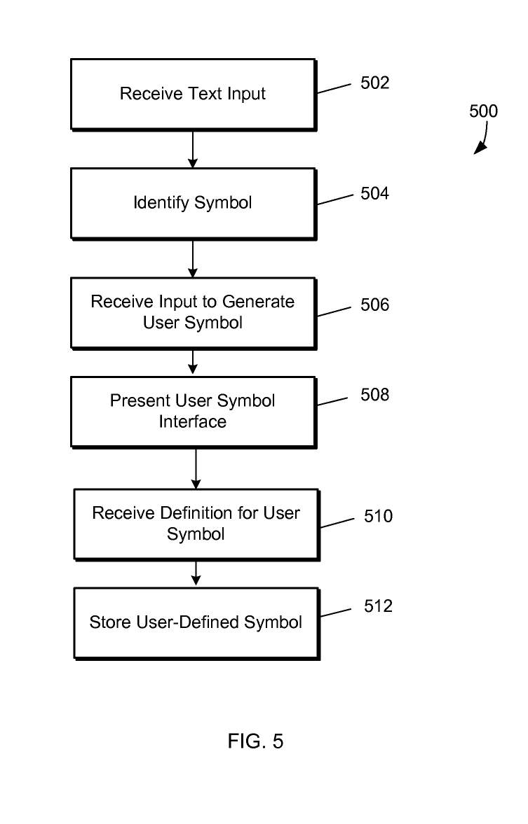

FIG. 5 is flow diagram 500 of an example user-defined symbol generation process. At step 502, text input is received. For example, text input can be received as described above with reference to step 402 of FIG. 4. At step 504, the current symbol input can be identified. For example, the symbol can be identified as described above with reference to step 404 of FIG. 4.

At step 506, input can be received indicating that the user would like to generate a user-defined symbol. For example, the user can select a graphical element to invoke a graphical interface for generating a user-defined symbol, as described with reference to FIG. 2. At step 508, a graphical interface can be presented for generating a user-defined symbol. For example, graphical interface 200 of FIG. 2 can be presented.

At step 510, a definition for the user-defined symbol can be received. For example, the definition can include one or more symbols that define the user-defined symbol and a textual description of the user-defined symbol. Once the user has defined and described the user-defined symbol, the symbol can be stored along with metadata identifying the user-defined symbol as a user-defined symbol, at step 512. For example, the user-defined symbol and associated metadata can be stored with the predefined symbols on the computing device. The user-defined symbol and associated metadata can be stored in a separate user symbol database that can be used to track and identify user-defined symbols.

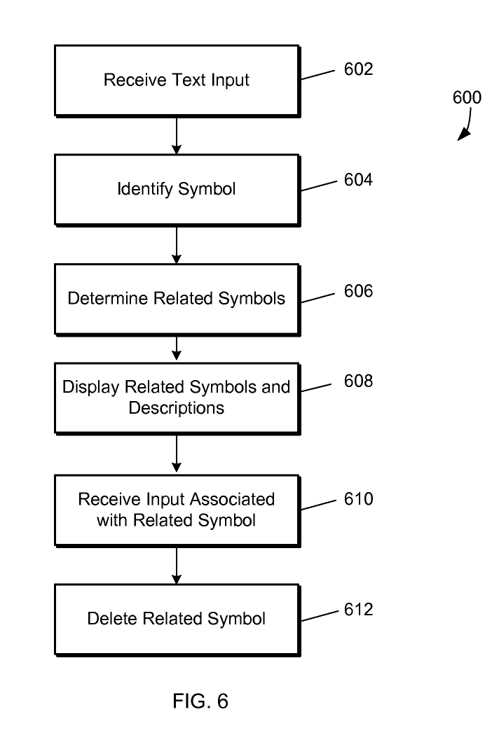

FIG. 6 is flow diagram 600 of an example symbol deletion process. At step 602, text input can be received. For example, text input can be received a described above in step 402 of FIG. 4. At step 604, a symbol in the text input can be identified, as described above in step 404 of FIG. 4. At step 606, related symbols can be determined, as described above in step 406 of FIG. 4. At step 608, the related symbols and descriptions can be displayed, as described above in step 408 of FIG. 4.

At step 610, input associated with a related symbol can be received. For example, the input can indicate that the user wishes to delete the related symbol. For example, the user can hover a cursor over a “Recent” or “User” label associated with a symbol to cause the label to change to a selectable graphical element (e.g., button) for deleting the associated symbol, as described with reference to FIG. 3. If the computing device is configured for touch input, the user can perform a touch gesture (e.g., a swipe gesture) associated with the related symbol to cause the label to change to a selectable graphical element for deleting the associated symbol.

At step 612, the related symbol can be deleted. For example, the user can select the selectable graphical element invoked in step 610 to delete the symbol from the recent symbols list or from the user-defined symbols list. For example, if the related symbol is labeled as a recently selected symbol (e.g., “Recent” label), then selecting the graphical element will cause the symbol to be removed from the recent symbols list. However, the symbol will not be deleted from the system and will still be available for future selection. If the related symbol is labeled as a user-defined symbol (e.g., “User” label), then selecting the graphical element will cause the user-defined symbol to be deleted from the computing device. The user-defined symbol will no longer be available for future selection.

### Example System Architecture

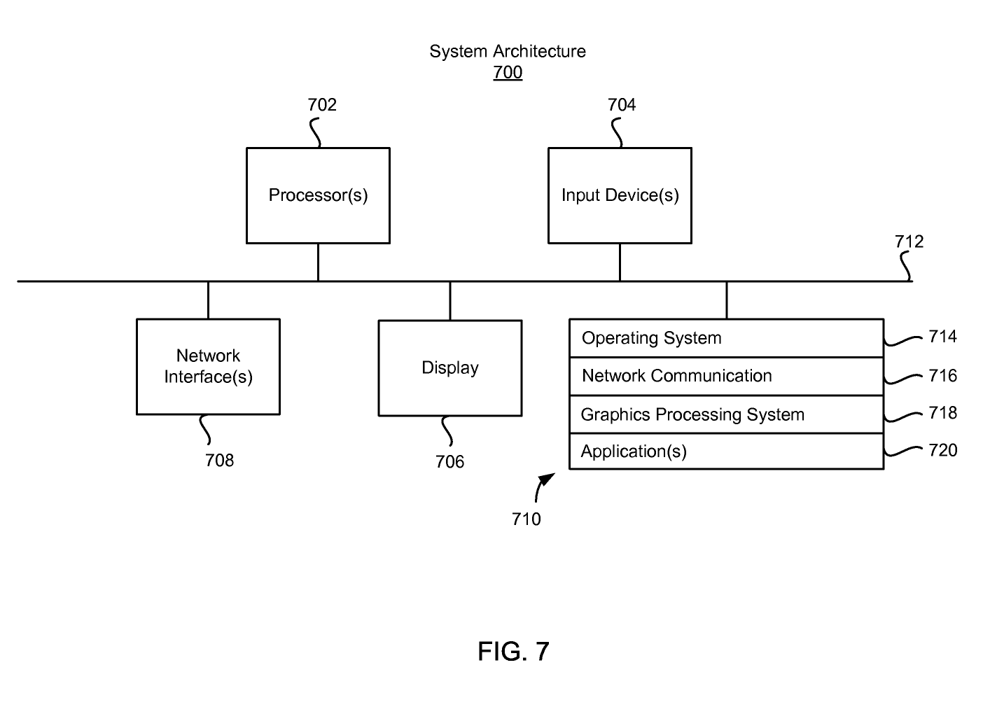

FIG. 7 is a block diagram of an exemplary system architecture implementing the features and processes of FIGS. 1-6. The architecture 700 can be implemented on any electronic device that runs software applications derived from compiled instructions, including without limitation personal computers, servers, smart phones, media players, electronic tablets, game consoles, email devices, etc. In some implementations, the architecture 700 can include one or more processors 702, one or more input devices 704, one or more display devices 706, one or more network interfaces 708 and one or more computer-readable mediums 710. Each of these components can be coupled by bus 712.

Display device 706 can be any known display technology, including but not limited to display devices using Liquid Crystal Display (LCD) or Light Emitting Diode (LED) technology. Processor(s) 702 can use any known processor technology, including but are not limited to graphics processors and multi-core processors. Input device 704 can be any known input device technology, including but not limited to a keyboard (including a virtual keyboard), mouse, track ball, and touch-sensitive pad or display. Bus 712 can be any known internal or external bus technology, including but not limited to ISA, EISA, PCI, PCI Express, NuBus, USB, Serial ATA or FireWire. Computer-readable medium 710 can be any medium that participates in providing instructions to processor(s) 702 for execution, including without limitation, non-volatile storage media (e.g., optical disks, magnetic disks, flash drives, etc.) or volatile media (e.g., SDRAM, ROM, etc.).

Computer-readable medium 710 can include various instructions 714 for implementing an operating system (e.g., Mac OS®, Windows®, Linux). The operating system can be multi-user, multiprocessing, multitasking, multithreading, real-time and the like. The operating system performs basic tasks, including but not limited to: recognizing input from input device 704; sending output to display device 706; keeping track of files and directories on computer-readable medium 710; controlling peripheral devices (e.g., disk drives, printers, etc.) which can be controlled directly or through an I/O controller; and managing traffic on bus 712. Network communications instructions 716 can establish and maintain network connections (e.g., software for implementing communication protocols, such as TCP/IP, HTTP, Ethernet, etc.).

A graphics processing system 718 can include instructions that provide graphics and image processing capabilities. Application(s) 720 can be an application that uses or implements the processes described in reference to FIGS. 1-6. The processes can also be implemented in operating system 714.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network. The relationship of client and server arises by virtue of computer programs running on the respective computers and having a client-server relationship to each other.

One or more features or steps of the disclosed embodiments can be implemented using an API. An API can define on or more parameters that are passed between a calling application and other software code (e.g., an operating system, library routine, function) that provides a service, that provides data, or that performs an operation or a computation.

The API can be implemented as one or more calls in program code that send or receive one or more parameters through a parameter list or other structure based on a call convention defined in an API specification document. A parameter can be a constant, a key, a data structure, an object, an object class, a variable, a data type, a pointer, an array, a list, or another call. API calls and parameters can be implemented in any programming language. The programming language can define the vocabulary and calling convention that a programmer will employ to access functions supporting the API.

In some implementations, an API call can report to an application the capabilities of a device running the application, such as input capability, output capability, processing capability, power capability, communications capability, etc.

A number of implementations have been described. Nevertheless, it will be understood that various modifications may be made. For example, other steps may be provided, or steps may be eliminated, from the described flows, and other components may be added to, or removed from, the described systems. Accordingly, other implementations are within the scope of the following claims.

What is claimed is:

1. A method comprising:
receiving text input at a computing device;
identifying a symbol in the text input;
based on the symbol, determining one or more related symbols;
generating data for presenting the related symbols and a description of the related symbols on a graphical interface of the computing device;
receiving a selection of one of the related symbols; and
replacing the symbol in the text input with the selected symbol.

2. The method of claim 1, where the related symbols include a user-defined symbol having one or more characters.

3. The method of claim 1, where the related symbols are sorted based on how frequently each of the one or more symbols is used.

4. The method of claim 1, where the related symbols are sorted based on how recently each of the related symbols was previously selected.

5. The method of claim 1, further comprising:
storing a plurality of symbols and information associating the symbol and the one or more related symbols; and
determining the one or more symbols based on the information.

6. The method of claim 1, wherein the symbol is a particular punctuation mark and the related symbols comprise other punctuation marks that resemble the particular punctuation mark

7. A method comprising:
receiving text input at a computing device;
identifying a symbol in the text input;
based on the symbol, determining one or more related symbols;
causing the related symbols and a description of the related symbols to be displayed on a graphical interface of the computing device, where at least one of the related symbols belongs to a category of symbols;
receiving a selection of the at least one related symbol; and
removing the at least one related symbol from the category of symbols.

8. The method of claim 7, where the category is associated with user-defined symbols.

9. The method of claim 7, where the category is associated with recently selected symbols.

10. The method of claim 7, where removing the at least one related symbol comprises deleting a user-defined symbol.

11. A non-transitory computer-readable medium including one or more sequences of instructions which, when executed by one or more processors, causes:
receiving text input at a computing device;
identifying a symbol in the text input;
based on the symbol, determining one or more related symbols;
generating data for presenting the related symbols and a description of the related symbols on a graphical interface of the computing device;
receiving a selection of one of the related symbols; and
replacing the symbol in the text input with the selected symbol.

12. The non-transitory computer-readable medium of claim 11, where the related symbols include a user-defined symbol having one or more characters.

13. The non-transitory computer-readable medium of claim 11, where the related symbols are sorted based on how frequently each of the one or more symbols is used.

14. The non-transitory computer-readable medium of claim 11, where the related symbols are sorted based on how recently each of the related symbols was previously selected.

15. The non-transitory computer-readable medium of claim 11, wherein the instructions cause:
storing a plurality of symbols and information associating the symbol and the one or more related symbols; and
determining the one or more symbols based on the information.

16. The non-transitory computer-readable medium of claim 11, wherein the symbol is a particular punctuation mark and the related symbols comprise other punctuation marks that resemble the particular punctuation mark

17. A non-transitory computer-readable medium including one or more sequences of instructions which, when executed by one or more processors, causes:
receiving text input at a computing device;
identifying a symbol in the text input;
based on the symbol, determining one or more related symbols;
causing the related symbols and a description of the related symbols to be displayed on a graphical interface of the computing device, where at least one of the related symbols belongs to a category of symbols;
receiving a selection of the at least one related symbol; and
removing the at least one related symbol from the category of symbols.

18. The non-transitory computer-readable medium of claim 17, where the category is associated with user-defined symbols.

19. The non-transitory computer-readable medium of claim 17, where the category is associated with recently selected symbols.

20. The non-transitory computer-readable medium of claim 17, where the instructions that cause removing the at least one related symbol comprise instructions that cause deleting a user-defined symbol.

21. A system comprising:
one or more processors; and
a non-transitory computer-readable medium including one or more sequences of instructions which, when executed by the one or more processors, causes:
receiving text input at a computing device;
identifying a symbol in the text input;
based on the symbol, determining one or more related symbols;
generating data for presenting the related symbols and a description of the related symbols on a graphical interface of the computing device;
receiving a selection of one of the related symbols; and
replacing the symbol in the text input with the selected symbol.

22. The system of claim 21, where the related symbols include a user-defined symbol having one or more characters.

23. The system of claim 21, where the related symbols are sorted based on how frequently each of the one or more symbols is used.

24. The system of claim 21, where the related symbols are sorted based on how recently each of the related symbols was previously selected.

25. The system of claim 21, wherein the instructions cause:
storing a plurality of symbols and information associating the symbol and the one or more related symbols; and
determining the one or more symbols based on the information.

26. The system of claim 21, wherein the symbol is a particular punctuation mark and the related symbols comprise other punctuation marks that resemble the particular punctuation mark

27. A system comprising:
one or more processors; and
a computer-readable medium including one or more sequences of instructions which, when executed by the one or more processors, causes:
receiving text input at a computing device;
identifying a symbol in the text input;
based on the symbol, determining one or more related symbols;
causing the related symbols and a description of the related symbols to be displayed on a graphical interface of the computing device, where at least one of the related symbols belongs to a category of symbols;
receiving a selection of the at least one related symbol; and
removing the at least one related symbol from the category of symbols.

28. The system of claim 27, where the category is associated with user-defined symbols.

29. The system of claim 27, where the category is associated with recently selected symbols.

30. The system of claim 27, where the instructions that cause removing the at least one related symbol comprise instructions that cause deleting a user-defined symbol.
